(19) United States
(12) Patent Application Publication
(10) Pub. No.: US 2015/0186195 A1
(43) Pub. Date: Jul. 2, 2015

(54) METHOD OF ANALYSIS APPLICATION OBJECT WHICH COMPUTER-EXECUTABLE, SERVER PERFORMING THE SAME AND STORAGE MEDIA STORING THE SAME

(71) Applicant: BD, lnc., Seoul (KR)

(72) Inventors: Chol Ho JONG, Seoul (KR); KEE YONG KIM, Seoul (KR)

(21) Appl. No.: 14/587,057

(22) Filed: Dec. 31, 2014

(30) Foreign Application Priority Data
Dec. 31, 2013 (KR) 10-2013-0168568

(51) Int. Cl. G06F 9/54; G06F 9/455

(52) U.S. Cl. CPC G06F 9/542; G06F 9/45533

(57) ABSTRACT

This application relates to a method of analyzing a computer-executable application object and the method includes associating a target control object with an application object to execute the target control object, analyzing the application object through the target control object to extract a scene component defined on the application object and identifying an event for the scene component to detect an event function and monitoring an execution procedure of the application object by the detected event function. Therefore, this application may extract a service flow for a test target application.

### CROSS-REFERENCE TO RELATED APPLICATIONS

Pursuant to 35 U.S.C. §119(a), this application claims the benefit of earlier filing date and right of priority to Korean Patent Application No. 10-2013-0168568, filed on Dec. 31, 2013, the contents of which are hereby incorporated by reference herein in their entirety.

### BACKGROUND OF THE INVENTION

1. Field of the Invention

The present invention relates to a technology of analyzing an application object, more particularly to a analyzing computer-executable application object, server performing the same and storage medium storing the same extracting a service flow for a test target application.

2. Background of the Invention

In general, when a new mobile phone is developed, a test for an application is performed for verifying stability and integrity of an application stored in the mobile phone. Specially, because a development cycle and a new product launching cycle of a mobile phone, a test time testing a mobile phone application is shortened. However, a specification of a new mobile phone is risen so that a test case verifying the mobile phone application is increased and complex.

The Korean Patent Registration No. 10-1087907 discloses a terminal function test technology testing whether a developed application is normally operated on terminals of various models. The test technology may build a test server including a plurality of virtual terminals being responded to terminals of various types on a network to speedy and easily test whether an additional service according to an application for a terminal is normally implemented in a real terminal environment.

The Korean Patent Registration No. 10-0775102 discloses a technology of estimating a quality test result of a platform based application in an embedded device testing a partial range for an application operation stability on the embedded device. The estimation technology may perform a test for a partial range to check a result same with a test of all range, thereby may remove a unstable quality factor in a commercial service environment of an application.

An application testing procedure may put many test user for maximally calculating an objective statistic. However, although many test user is putted, a subjective viewpoint may be included in the application testing procedure to be spent money and time.

### SUMMARY OF THE INVENTION

Example embodiments of the present invention propose a method of analyzing an application object capable of extracting a service flow for a test target application.

Example embodiments of the present invention propose a method of analyzing an application object capable of linking a test application and a test target application to monitor the target application through a test application.

Example embodiments of the present invention propose a method of analyzing an application object capable of extracting an event listener being included in a test application to generate a service flow.

In some embodiments, a method of analyzing an application object includes associating a target control object with an application object to execute the target control object, analyzing the application object through the target control object to extract a scene component defined on the application object and identifying an event for the scene component to detect an event function and monitoring an execution procedure of the application object by the detected event function.

In one embodiment, the method may further include generating an analysis virtual machine being connected with a cloud computing based user terminal.

Associating a target control object with an application object to execute the target control object may include detecting an identifier of the application object and an execution type of the application object in the application object.

Associating a target control object with an application object to execute the target control object may include forcingly terminating the application object when the application object is executed before associating the target control object with the application object.

In one embodiment, associating a target control object with an application object to execute the target control object may include decompiling the target control object and the application object to generate a new version for the associated target control object and the application object.

Associating a target control object with an application object to execute the target control object may include storing real time log data for the target control object in an object database or processing the real time log data through an in-memory scheme.

In one embodiment, analyzing the application object through the target control object to extract a scene component defined on the application object may include analyzing source data and resource data of the application object to detect at least one metadata based on the source data and the resource data.

Analyzing the application object through the target control object to extract a scene component defined in the application object may include detecting at least one of an OS (Operating System) version, resolution information, whether multi languages are supported and whether a multi resolution is supported for the application object based on the source data and the resource data.

The source data may include at least one of an input value, whether it is a push, exception processing information and timer information.

Monitoring an execution procedure of the application object by the detected event function may further include measuring a rendering time of the application object by the event function.

In one embodiment, the method may further include generating at least one service flow for the application object according to the execution procedure. The at least one service flow is generated according to a navigation rule including at least one of a cyclic structure and an acyclic structure.

Generating at least one service flow for the application object according to the execution procedure may further include assigning identification information for each of at least one flow object included in the generated service flow.

In one embodiment, the method may further include displaying an analysis result for the application object by a flow included in the generated service flow.

In some embodiment, a server of analyzing an application object includes an object executing unit configured to associate a target control object with an application object to execute the target control object, a scene component extracting unit configured to analyze the application object through the target control object to extract a scene component defined on the application object and an application object monitoring unit configured to identify an event for the scene component to detect an event function and monitoring an execution procedure of the application object by the detected event function.

In one embodiment, the server may further include a service flow generating unit configured to generate an analysis virtual machine being connected with a cloud computing based user terminal.

In one embodiment, the server may further include an analysis result display unit configured to display an analysis result for the application object by a flow included in the generated service flow.

In some embodiment, a machine-readable non-transitory medium storing a computer program for a method of analyzing computer-executable application object, the method includes associating a target control object with an application object to execute the target control object, analyzing the application object through the target control object to extract a scene component defined on the application object and identifying an event for the scene component to detect an event function and monitoring an execution procedure of the application object by the detected event function.

The method of analyzing an application object and related technologies according to an example embodiment may extract a service flow for a test target application.

The method of analyzing an application object and related technologies according to an example embodiment may link a test application and a test target application to monitor the target application through a test application.

The method of analyzing an application object and related technologies according to an example embodiment may extract an event listener being included in a test application to generate a service flow.

### BRIEF DESCRIPTION OF THE DRAWINGS

FIG. 1 is a block diagram illustrating an application object analysis system according to an example embodiment of the present invention.

FIG. 2 is a block diagram illustrating an application object analysis server in FIG. 1.

FIG. 3 is a flow chart illustrating an application object analysis procedure being performed on an application object analysis server in FIG. 1.

FIG. 4 is a diagram illustrating a first analysis result scene being displayed on an application object analysis server in FIG. 1.

FIG. 5 is a diagram illustrating a second analysis result scene being displayed on an application object analysis server in FIG. 1.

### DETAILED DESCRIPTION OF THE EMBODIMENTS

Explanation of the present invention is merely an embodiment for structural or functional explanation, so the scope of the present invention should not be construed to be limited to the embodiments explained in the embodiment. That is, since the embodiments may be implemented in several forms without departing from the characteristics thereof, it should also be understood that the described embodiments are not limited by any of the details of the foregoing description, unless otherwise specified, but rather should be construed broadly within its scope as defined on the appended claims. Therefore, various changes and modifications that fall within the scope of the claims, or equivalents of such scope are therefore intended to be embraced by the appended claims.

Terms described in the present disclosure may be understood as follows.

While terms such as “first” and “second,” etc., may be used to describe various components, such components must not be understood as being limited to the above terms. The above terms are used to distinguish one component from another. For example, a first component may be referred to as a second component without departing from the scope of rights of the present invention, and likewise a second component may be referred to as a first component.

It will be understood that when an element is referred to as being “connected to” another element, it can be directly connected to the other element or intervening elements may also be present. In contrast, when an element is referred to as being “directly connected to” another element, no intervening elements are present. In addition, unless explicitly described to the contrary, the word “comprise” and variations such as “comprises” or “comprising,” will be understood to imply the inclusion of stated elements but not the exclusion of any other elements. Meanwhile, other expressions describing relationships between components such as “between”, “immediately between” or “adjacent to” and “directly adjacent to” may be construed similarly.

Singular forms “a”, “an” and “the” in the present disclosure are intended to include the plural forms as well, unless the context clearly indicates otherwise. It will be further understood that terms such as “including” or “having,” etc., are intended to indicate the existence of the features, numbers, operations, actions, components, parts, or combinations thereof disclosed in the specification, and are not intended to preclude the possibility that one or more other features, numbers, operations, actions, components, parts, or combinations thereof may exist or may be added.

Identification letters (e.g., a, b, c, etc.) in respective steps are used for the sake of explanation and do not described order of respective steps. The respective steps may be changed from a mentioned order unless specifically mentioned in context. Namely, respective steps may be performed in the same order as described, may be substantially simultaneously performed, or may be performed in reverse order.

The present invention may be implemented as machine-readable codes on a machine-readable medium. The machine-readable medium includes any type of recording device for storing machine-readable data. Examples of the machine-readable recording medium include a read-only memory (ROM), a random access memory (RAM), a compact disk-read only memory (CD-ROM), a magnetic tape, a floppy disk, and optical data storage. The medium may also be carrier waves (e.g., Internet transmission). The computer-readable recording medium may be distributed among networked machine systems which store and execute machine-readable codes in a de-centralized manner.

The terms used in the present application are merely used to describe particular embodiments, and are not intended to limit the present invention. Unless otherwise defined, all terms used herein, including technical or scientific terms, have the same meanings as those generally understood by those with ordinary knowledge in the field of art to which the present invention belongs. Such terms as those defined on a generally used dictionary are to be interpreted to have the meanings equal to the contextual meanings in the relevant field of art, and are not to be interpreted to have ideal or excessively formal meanings unless clearly defined on the present application.

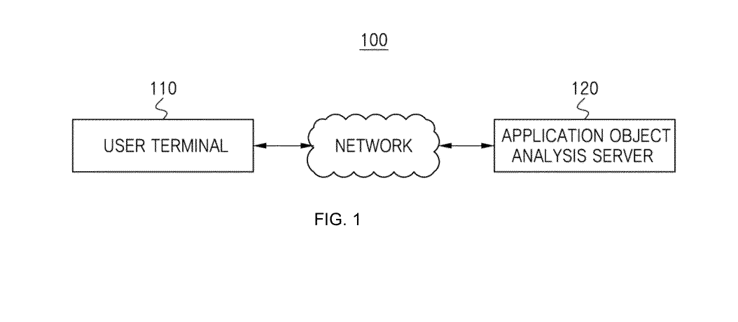

FIG. 1 is a block diagram illustrating an application object analysis system according to an example embodiment of the present invention.

Referring to FIG. 1, an application object analysis system 100 includes a user terminal 110 and an application object analysis server 120.

The user terminal 110 may be connected with the application object analysis server 120 through an online network environment to receive a service flow for an application object from the application object analysis server 120. For example, the user terminal 110 may correspond to a computing device such as a PC (Personal Computer), a smart phone, a PDA (Personal Digital Assistant), a tablet PC including a central processing unit, a memory unit and input and output unit.

In one embodiment, the user terminal 110 may be implemented based on a cloud computing. The user terminal 110 may be implemented based on the cloud computing to install an analysis virtual machine through the application object analysis server 120.

That is, the user terminal 110 may be implemented as a real device or a virtual device.

The application object analysis server 120 may be connected with at least one user terminal 110 through an online network environment to provide the service flow for the application object to the at least one user terminal 110. The application corresponds to an application software being installed in the computing device to be executable for a specific operation. Herein, the application object analysis server 120 may be implemented as a plurality of distributed-processable computing devices without being limited to a single computing device.

The application object analysis server 120 may implement information for the service flow transmitting to the at least one user terminal 110 on a physical storage medium (e.g., CD-ROM) or an electrical storage medium (e.g., a carrier wave).

In one embodiment, the application object analysis server 120 may generate an analysis virtual machine being connected with the cloud computing based user terminal 110. The application object analysis server 120 may provide a virtual machine access program implemented as a computer-readable storage medium to the user terminal 110. Herein, the provision may include a computer program distribution, a computer program execution on a virtual or cloud environment.

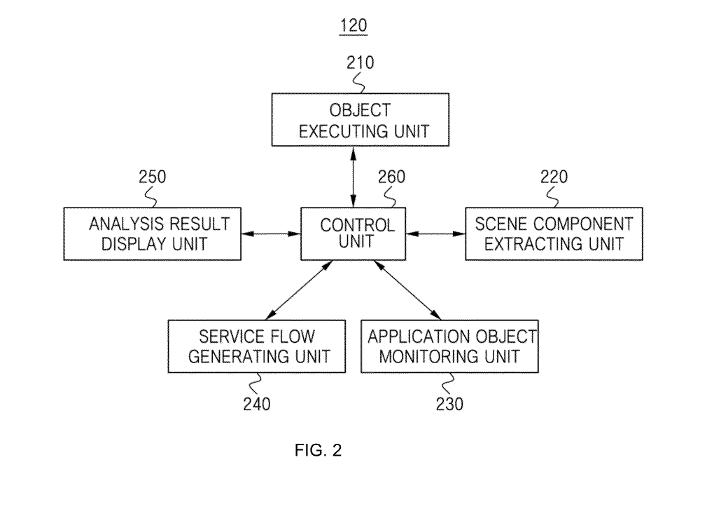

FIG. 2 is a block diagram illustrating an application object analysis server in FIG. 1.

Referring to FIG. 2, the application object analysis server 120 includes an object executing unit 210, a scene component extracting unit 220, an application object monitoring unit 230, a service flow generating unit 240, an analysis result display unit 250 and a control unit 260.

The object executing unit 210 associates a target control object with the application object to execute the target control object. The target control object corresponds to an application software implemented by a developer for extracting a specific event from the application object. The application object corresponds to a software being executed in an operating system and includes at least one event to provide a service responding to the at least one event to a user.

The object executing unit 210 may associate the application object with the target control object to cause the target control object and the application object to be executed on a same process and to cause the target control object to control the application object. In one embodiment, the target control object may be associated with the application object through an instrumentation element. The instrumentation element provides information calling any part in the application object when an event occurs while the application object is executed.

The object executing unit 210 may detect an identifier of the application object and an execution type of the application object in the application object. The identifier of the application object may correspond to an identification code assigned to each of a plurality of application objects for identifying each of the plurality of application objects. An execution type of the application object may include a thread type and a step-by-step type. In one embodiment, the object executing unit 210 may detect the identifier of the application object and the execution type of the application object to include the detected identifier and execution type in the instrumentation element.

The object executing unit 210 may decompile the target control object and the application object to generate a new version for the associated target control object and application object. The decompile performs disassembling each of the target control object and the application object having an APK (Android PacKage) extension and the disassembled target control object and application object is set to be changeable.

In one embodiment, the object executing unit 210 may compile the target control object associated with the application objet to execute the compiled target control object. Herein, target control object is used for conveniences' sake to explain an example embodiment but should not be used to limit a scope of the present invention. Therefore, the object executing unit 210 may execute a new version object generated by association with the target control object and the application object.

When the object executing unit 210 associates the target control object with the application to execute the target control object, the object executing unit 210 may store log data for the target control object in an object database. The log data may include developer information of the target control object, an identifier of associated application object and an execution time of the target control object. In one embodiment, the object database may store the log data by the identifier of the application object.

When the object executing unit 210 associates the target control object with the application to execute the target control object, the object executing unit 210 may process the application object through an in-memory scheme.

The scene component extracting unit 220 analyzes the application object through the target control object to extract a scene component defined on the application object. The scene component corresponds to an individual scene forming the service flow. The scene component may be formed at least one view object.

The scene component extracting unit 220 may analyze the source data and the resource data of the application object to detect at least one metadata based on each of the source data and the resource data. The source data may include at least one of an input value (i.e., input data), whether it is a push, exception processing information and timer information. In one embodiment, the scene component extracting unit 220 may store the at least one metadata detected based on the source data in the object database.

The scene component extracting unit 220 may detect at least one of an OS (Operating System) version, resolution information, whether multi languages are supported and whether a multi resolution is supported for the application object based on the source data. The scene component extracting unit 220 may determine minimum and maximum versions of the OS to check whether the OS version corresponds to a range between the minimum version and the maximum version. In one embodiment, the scene component extracting unit 220 may analyze the application object by the OS version to check whether the application object is compatible with a device.

The scene component extracting unit 220 may analyze a language compatibility for the application object to obtain language information being available in the application object.

The application object monitoring unit 230 identifies an event for the scene component to detect an event function and monitors an execution procedure of the application object by the detected event function. The event function may be responded to at least one event of the application object to execute the at least one event. The event may include a click event, a key event and a touch event. For example, the event function may correspond to an event listener.

The application object monitoring unit 230 may detect the event function responding to the at least one metadata. The metadata may include the identifier of the application object, package information of the application object and version information of the application object.

The application object monitoring unit 230 may measure a rendering time of the application object by the event function. The rendering time of the application object is a required time where the application is loaded and executed. Herein, the more the rendering time of the application object is shorter, the more a performance of the application object is better. Herein, the rendering time of the application object may be randomly set by the user unrelated to the required time. For example, although the rendering time of the application object is 3 seconds, the rendering time of the application object may be randomly set as 5 second by the user. Herein, the rendering time being randomly set by the user may be longer than the rendering time where the application is loaded and executed.

In one embodiment, the application object monitoring unit 230 may monitor an execution procedure of the application object to measure a success probability and a failure probability (i.e., an error probability) for the event function defined on the application object. For example, the application object monitoring unit 230 may measure the success probability and the failure probability for each of the at least of event function, calculate an arithmetic mean for the success probability and the failure probability to measure a success probability and a failure probability for the application object.

The application object monitoring unit 230 may analyze a relationship between the at least one event function defined on the application object. Herein, the service flow may be generated based on the relationship between the at least one event function.

The service flow generating unit 240 generates at least one service flow for the application object according to the execution procedure of the application object. The service flow may be generated based on attribute definition data and flow definition data. The attribute definition data may include information for the event responding to the event function and the flow definition data may have a directivity and include information for the attribute definition data being connected with each other. That is, the flow definition data may connect the attribute definition data.

In one embodiment, the service flow generating unit 240 may generate the at least one service flow including at least one of a cyclic structure and an acyclic structure. The cyclic structure includes a cyclic loop being started from a specific attribute definition data to come back to the specific attribute definition data and the acyclic structure does not include the cyclic loop.

The service flow generating unit 240 may generate the service flow based on the relationship between the at least one event function analyzed in the application object monitoring unit 230. In one embodiment, the service flow generating unit 240 may generate the service flow by the event function to provide the service flow in real time. The service flow may be gradually increased according to a process of the execution procedure of the application object.

The service flow generating unit 240 may assign an identification information for each of at least one flow object included in the generated service flow. The at least one flow object may include the attribute definition data and the flow definition data. For example, the service flow generating unit 240 may assign the identification information to each of the attribute definition data and the flow definition data and may refer another attribute definition data or another flow definition data having the relationship between each other through each of the identification information. Herein, the identification information may be implemented as a primary key or a foreign key.

The analysis result display unit 250 displays an analysis result for the application object by a flow included in the service flow.

In one embodiment, the analysis result display unit 250 may separate an internal layout to display basic information for the application object, trend information for the application object and detail information for the application object on a display screen of the user terminal 110. The basic information for the application object corresponds to most basic analysis information representing the application object. The trend information for the application object corresponds to a graph representing a change trend (e.g., a change for a quality, security, issue, code and function) by the OS version of the application object. The detail information for the application object may include detail analysis information, activity information, resource information and test metadata information for the application object.

In another embodiment, the analysis result display unit 250 may separate the internal layout to display information extracted from the application object through the target control object on the display screen of the user terminal 110. The information extracted from the application object may include the analysis result graph of the application object, the basic information for the application object, scene component information for the application object and the flow information for the application object.

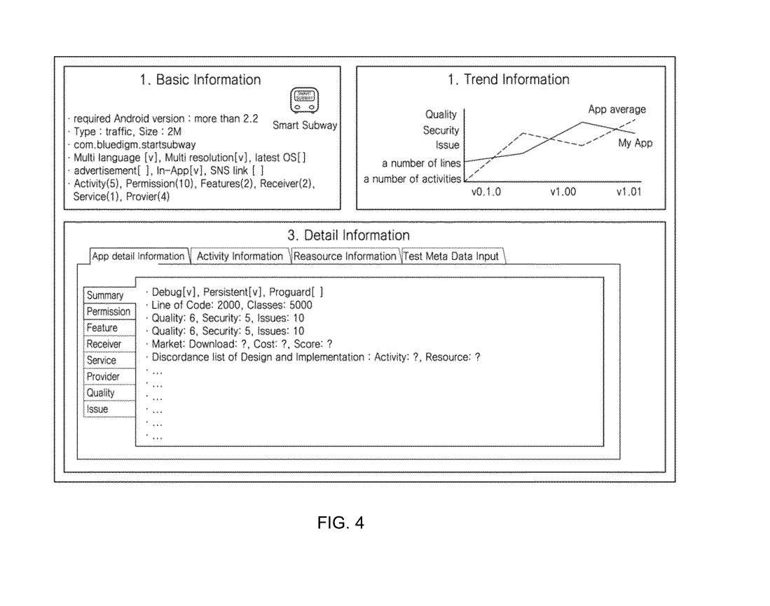

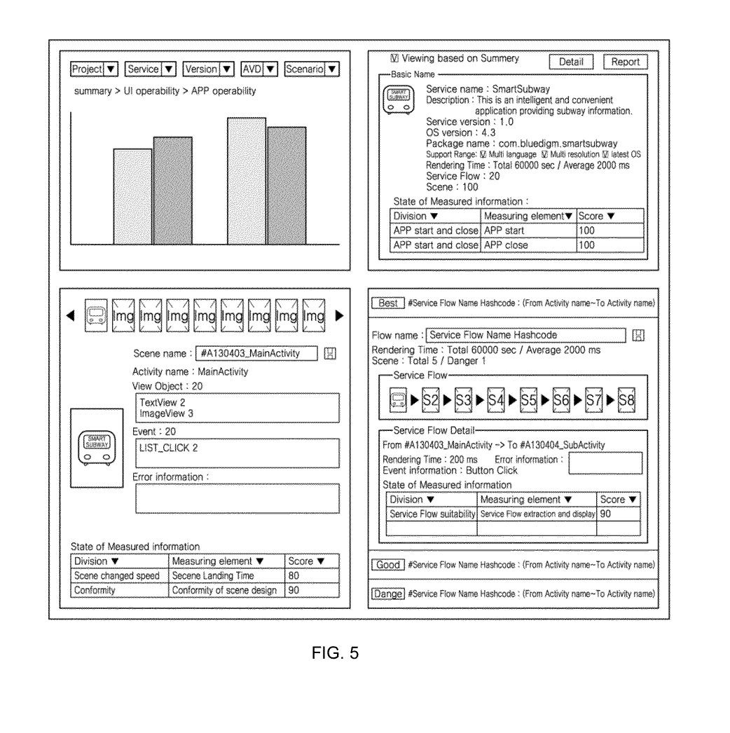

In below, the analysis result scene for the application object will be described in FIG. 4 and FIG. 5.

The control unit 260 may control all operation of the application object analysis server 120 and may control a control flow or data flow of the object executing unit 210, the scene component extracting unit 220, the application object monitoring unit 230, the service flow generating unit 240 and the analysis result display unit 250.

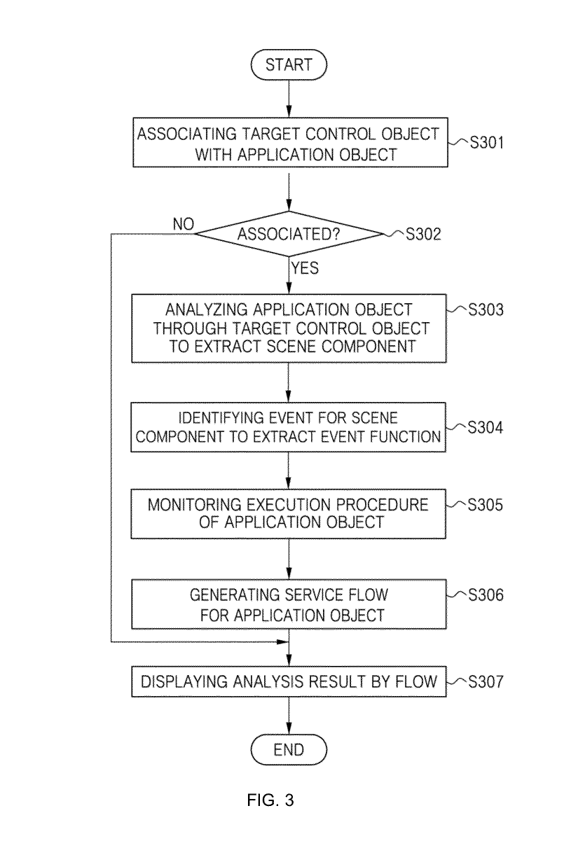

FIG. 3 is a flow chart illustrating an application object analysis procedure being performed on an application object analysis server in FIG. 1.

Referring to FIG. 3, the object executing unit 210 associates the target control object with the application object (Step S301).

The object executing unit 210 may associate the target control object with the application object to cause the target control object and the application object to be executed on a same process and may cause the target control object to control the application object.

The object executing unit 210 may detect the identifier of the application object and the execution type of the application object. The identifier of the application object may correspond to the identification code assigned to each of the plurality of application objects for identifying each of the plurality of application objects. The execution type of the application object may include the thread type and the step-by-step type.

The object executing unit 210 may check whether the application object is executed before associating the target control object with the application object. Whether the application object is executed may be checked based on a memory usage of the application object. When the application object is executed, the object executing unit 210 may forcingly terminate the application object. For example, the object executing unit 210 may delete the log data recorded from after the application object is executed to forcingly terminate the application object by initializing the application object.

In one embodiment, the object executing unit 210 may associate the target control object with the application object to store the log data for the target control object in the object database when the target control object is executed.

In another embodiment, the object executing unit 210 may associate the target control object with the application object to process the application object through the in-memory scheme when the target control object is executed.

When the target control object is associated with the application object, the scene component extracting unit 220 analyzes the application object through the target control object to extract the scene component defined on the application object (Steps S302 and S303).

The scene component extracting unit 220 may detect at least one of the OS (Operating System) version, the resolution information, whether the multi languages are supported and whether the multi resolution is supported for the application object based on the source data. The scene component extracting unit 220 may determine minimum and maximum versions of the OS to check whether the OS version corresponds to a range between the minimum version and the maximum version. In one embodiment, the scene component extracting unit 220 may analyze the application object by the OS version to check whether the application object is compatible with a device.

The application object monitoring unit 230 identifies the event for the scene component to detect the event function (Step S304).

The application object monitoring unit 230 monitors the execution procedure of the application object by the detected event function (Step S305).

In one embodiment, the application object monitoring unit 230 may measure the rendering time of the application object by the event function.

In another embodiment, the application object monitoring unit 230 may monitor the execution procedure of the application object to measure the success probability and the failure probability (i.e., the error probability) for the event function defined on the application object.

The application object monitoring unit 230 may analyze the relationship between the at least one event function defined on the application object. Herein, the service flow may be generated based on the relationship between the at least one event function.

In one embodiment, when the target control object is executed, the application object monitoring unit 230 may mirror the application object associated with the target control object, analyze the log data for the application object or analyze the relationship between the event function based on the object database. The mirroring is a skill monitoring a compile route of the application object to collect the relationship between the event function. The log data corresponds to information recorded for a compile result of the application object. The object database corresponds to an internal storage of the application object analysis server 120 storing the event function responded to the event being generated in the application object after the target control object is executed by the identifier of the application object.

The service flow generating unit 240 generates the at least one service flow for the application object according to the execution procedure of the application object (Step S306).

In one embodiment, the service flow may be generated based on the attribute definition data and flow definition data. The attribute definition data may include information for the event responding to the event function and the flow definition data may have a directivity and include information for the attribute definition data being connected with each other. That is, the flow definition data may connect the attribute definition data.

The service flow generating unit 240 the service flow based on the relationship between the at least one event function analyzed in the application object monitoring unit 230.

The service flow generating unit 240 may assign the identification information for each of at least one flow object included in the generated service flow. The at least one flow object may include the attribute definition data and the flow definition data. Herein, the identification information for each of the at least one flow object may be implemented as a primary key or a foreign key.

The analysis result display unit 250 displays an analysis result for the application object by a flow included in the service flow.

In one embodiment, the analysis result display unit 250 may separate an internal layout to display the basic information for the application object, the trend information for the application object and the detail information for the application object on a display screen of the user terminal 110.

In another embodiment, the analysis result display unit 250 may separate the internal layout to display information extracted from the application object through the target control object on the display screen of the user terminal 110.

FIG. 4 is a diagram illustrating a first analysis result scene being displayed on an application object analysis server in FIG. 1.

Referring to FIG. 4, the analysis result display unit 250 may display an icon image of the application object, summery information (e.g., a smart subway, type, size) of the application object, a support range (e.g., more than 2.2 version), a specific function (e.g., multi languages, multi resolution, SNS link) of the application object and component statistical information (e.g., Activity(5), Permission(10), Features(2)) of the application object as the basic information for the application object.

The analysis result display unit 250 may display measurement information (e.g., representation as a bar graph) compared with an average between the application object and another application object similar with the application object and a change trend (e.g., a quality, a security, an issue, a number of line, a number of activities) by the version for the application object as the trend information of the application object.

The analysis result display unit 250 may display a component list for the application object, discordance information of design and implementation for the application object, multi languages and multi resolution information of the application object, a performance and a security issue of the application object, activity attribute information of the application object, view detail information of the application object, resource information of the application object, resource summery information of the application object, resource detail information of the application object, user input information by the scene component of the application object, timer set information of the application object, exception management information for the application object and push message set information for the application object as the detail information of the application object.

FIG. 5 is a diagram illustrating a second analysis result scene being displayed on an application object analysis server in FIG. 1.

Referring to FIG. 5, the analysis result display unit 250 may display a vertical bar graph by a metrics index as the analysis result graph of the application object.

The analysis result display unit 250 may display an icon image of the application object, a service name (e.g., Smart Subway) of the application object, detail information of the application object, a service version (e.g., 1.0) of the application object, an OS version (e.g., 4.3) of the application object, a package name of the application object, a support range (e.g., multi languages, multi resolution, latest SNS) of the application object, a rendering time of the application object, a number of service flow of the application object, a number of scene component of the application object.

The analysis result display unit 250 may display a scene component image list of the application object, a scene component name of the application object, an activity name of the application object, view object information of the application object, event information of the application object, error information of the application object, matrix index score of the application object as scene component information for the application object.

The analysis result display unit 250 may display a service flow list of the application object, a corresponding service flow name of the application object, the rendering time of the application object, a number of scene component of the application object, a flow diagram for the service flow of the application object, flow detail information of the application object included in the service flow and matrix index score for the service flow of the application object as flow information for the application object.

Although this document provides descriptions of preferred embodiments of the present invention, it would be understood by those skilled in the art that the present invention can be modified or changed in various ways without departing from the technical principles and scope defined by the appended claims.

### DESCRIPTION OF SYMBOLS

100: APPLICATION OBJECT ANALYSIS SYSTEM

110: USER TERMINAL

120: APPLICATION OBJECT ANALYSIS SERVER

210: OBJECT EXECUTING UNIT

220: SCENE COMPONENT EXTRACTING UNIT

230: APPLICATION OBJECT MONITORING UNIT

240: SERVICE FLOW GENERATING UNIT

250: ANALYSIS RESULT DISPLAY UNIT

260: CONTROL UNIT

What is claimed is:

1. A method of analyzing computer-executable application object, the method comprising:
associating a target control object with an application object to execute the target control object;
analyzing the application object through the target control object to extract a scene component defined on the application object; and
identifying an event for the scene component to detect an event function and monitoring an execution procedure of the application object by the detected event function.

2. The method of claim 1, further comprising:
generating an analysis virtual machine being connected with a cloud computing based user terminal.

3. The method of claim 1, wherein associating a target control object with an application object to execute the target control object includes detecting an identifier of the application object and an execution type of the application object in the application object.

4. The method of claim 1, associating a target control object with an application object to execute the target control object includes forcingly terminating the application object when the application object is executed before associating the target control object with the application object.

5. The method of claim 1, wherein associating a target control object with an application object to execute the target control object includes decompiling the target control object and the application object to generate a new version for the associated target control object and the application object.

6. The method of claim 1, wherein associating a target control object with an application object to execute the target control object includes storing real time log data for the target control object in an object database or processing the real time log data through an in-memory scheme.

7. The method of claim 1, wherein analyzing the application object through the target control object to extract a scene component defined on the application object includes analyzing source data and resource data of the application object to detect at least one metadata based on the source data and the resource data.

8. The method of claim 1, analyzing the application object through the target control object to extract a scene component defined on the application object includes detecting at least one of an OS (Operating System) version, resolution information, whether multi languages are supported and whether a multi resolution is supported for the application object based on the source data and the resource data.

9. The method of claim 7, wherein the source data includes at least one of an input value, whether it is a push, exception processing information and timer information.

10. The method of claim 1, wherein monitoring an execution procedure of the application object by the detected event function further includes measuring a rendering time of the application object by the event function.

11. The method of claim 1, further comprising:
generating at least one service flow for the application object according to the execution procedure.

12. The method of claim 11, wherein the at least one service flow is generated according to a navigation rule including at least one of a cyclic structure and an acyclic structure.

13. The method of claim 11, wherein generating at least one service flow for the application object according to the execution procedure further includes assigning identification information for each of at least one flow object included in the generated service flow.

14. The method of claim 1, further comprising:
displaying an analysis result for the application object by a flow included in the generated service flow.

15. A server of analyzing computer-executable application object, the server comprising:
an object executing unit configured to associate a target control object with an application object to execute the target control object;
a scene component extracting unit configured to analyze the application object through the target control object to extract a scene component defined on the application object; and
an application object monitoring unit configured to identify an event for the scene component to detect an event function and monitoring an execution procedure of the application object by the detected event function.

16. The server of claim 15, further comprising:
a service flow generating unit configured to generate an analysis virtual machine being connected with a cloud computing based user terminal.

17. The server of claim 16, further comprising:
an analysis result display unit configured to display an analysis result for the application object by a flow included in the generated service flow.

18. A machine-readable non-transitory medium storing a computer program for a method of analyzing computer-executable application object, the machine-readable non-transitory medium having stored thereon machine-executable instructions for:
associating a target control object with an application object to execute the target control object;
analyzing the application object through the target control object to extract a scene component defined on the application object; and
identifying an event for the scene component to detect an event function and monitoring an execution procedure of the application object by the detected event function.
